(19) United States
(12) Patent Application Publication
(10) Pub. No.: US 2022/0000045 A1
(43) Pub. Date: Jan. 6, 2022

(54) CLIMATE CELL FOR PLANT CULTIVATION, HAVING AN OPTIMIZED CLIMATE SYSTEM

(71) Applicants: Viessmann Refrigeration Solutions GmbH, Allendorf (DE); &ever GmbH, Munich (DE)

(72) Inventors: Markus HÄSSLER-MARAUN, Allendorf (DE); Torsten MENZEL, Allendorf (DE); Andreas MAUL, Allendorf (DE); Timm RÖSSEL, Allendorf (DE); Frank WINTERS, Allendorf (DE); Mark KORZILIUS, Munich (DE)

(21) Appl. No.: 17/290,392

(22) PCT Filed: Nov. 4, 2019
(86) PCT No.: PCT/EP2019/080070

§ 371 Date: Apr. 30, 2021

(30) Foreign Application Priority Data
Nov. 2, 2018 (DE) 10 2018 127 404.1

(51) Int. Cl. A01G 9/24; A01G 9/02

(52) U.S. Cl. CPC A01G 9/246; A01G 9/023; A01G 9/249

(57) ABSTRACT

In order to climatically optimise and keep as flexible as possible a sealed climate cell for plant cultivation in a plurality of layers which are arranged one over the other and which each have at least one plant cultivation container and a lighting platform arranged thereabove, it is proposed that a first climate system of the climate cell has at least one air bag, which runs in the height direction, is arranged within the climate cell, and is designed to supply air to the individual layers in the first cultivation region.

The invention relates to a sealed climate cell for plant cultivation in a plurality of layers arranged one over the other, each layer having at least one plant cultivation container and a lighting platform arranged thereabove. By means of a ventilation unit of a first climate system, a climate is controlled in a first cultivation region within the climate cell.

The cultivation of plants in greenhouses is well known. In that case, it was customary to use artificial light in the evening hours and winter months in order to accelerate the growth of the plant. Due to the further development of LED-based light sources, power-intensive light sources can now be replaced and positioned in the immediate vicinity of the plant as a result of the comparatively low heat generation. This in turn enables the arrangement of a plurality of layers above each other, with plant areas arranged vertically above each other and permanent artificial light installed in between.

### PRIOR ART

DE 1 928 939 A describes a climate chamber for cultivating plants indoors.

DE 1 778 624 A describes a device for conditioning air for a climate chamber.

DE 10 2016 121 126 B3 describes a climatically sealed climate cell for cultivating plants indoors, wherein a plurality of containers are arranged one above the other in at least two layers within the climate cell. Each container has a receiving region with a substrate arranged in a flat manner for receiving the plants and/or for receiving seeds, the container having a frame circumferentially surrounding the receiving region.

### Disclosure of the Invention: Problem, Solution, Advantages

It is the object of the present invention to improve a sealed climate cell for plant cultivation in a plurality of layers arranged one above the other in respect of the climate control within the climate cell, in such a way that an optimally and in a flexible manner controllable air supply can be provided for the plants in the individual layers.

According to the invention, for this purpose a sealed climate cell for plant cultivation is provided in a plurality of layers arranged one above the other, each layer having at least one plant cultivation container and a lighting platform arranged thereabove. By means of a ventilation unit of a first climate system, a climate is controlled in a first cultivation region within the climate cell. The first climate system has at least one air bag which runs in the height direction of the climate cell, is arranged within the climate cell, and is designed to supply air to the individual layers in the first cultivation region.

According to the invention, a sealed climate cell is understood to mean a climate cell closed on six sides for cultivating plants indoors. By means of the climate system, the climate within the sealed climate cell is adapted to the needs of the plants, also depending on the particular growth phase, or is controlled accordingly. In particular, the temperature, the humidity, the carbon dioxide content and the flow rate of the air are controlled for this purpose. One advantage of the sealed climate cell is, in particular, that less water is used compared to conventional cultivation methods, since not much moisture escapes in the sealed system and thus less water needs to be added for the plants.

The plant cultivation containers can be trough-shaped and can have one or more receiving regions for plants or seeds. A plurality of plant cultivation containers can also be arranged next to each other in a trough-shaped carrier. A substrate is arranged in the receiving region of each plant cultivation container, and the seed or the plant sits on said substrate. The corresponding nutrient solution is preferably passed along underneath the substrate.

The lighting platform preferably has substantially the same external dimensions as the plant cultivation container or the carrier with a plurality of plant cultivation containers arranged next to each other. Each lighting platform can have a plurality of lighting means, in particular LEDs, and also optionally sensors and/or cameras. Preferably, the lighting means may also consist of hybrid light, that is to say a mixture of daylight and artificially generated light. The daylight can, for example, be guided into the sealed climate chamber via mirrors and fibre optics and distributed there. Sensors can measure the strength and composition of the daylight and can control the lighting means so that components missing in the spectrum of daylight are supplemented, for example via LEDs. The lighting means can be used to adjust the lighting to the conditions of the plant depending on the current growth phase. For this purpose, the lighting platforms respectively the lighting means of the lighting platforms can preferably be controlled in automated fashion. By means of the optional sensors and/or cameras, the actual state of the climate within the sealed climate cell as well as the current growth phase of the plant can be determined. Based on this data, the lighting platforms and/or the climate system respectively the particular ventilation unit of a climate system can then be controlled.

The air bag is fluidically connected to the ventilation unit of the particular climate system and serves to supply air to the individual levels respectively layers. For this purpose, the air from the ventilation unit flows through the air bag and is released into the cultivation region at the height of the individual layers. Since the air bag is arranged in height direction, respectively vertically, within the climate cell, the direction of flow from the ventilation unit can be from bottom to top or vice versa. Preferably, the air bag is tubular and/or fabric-like.

In principle, the ventilation unit of the particular climate system could be arranged in the upper or lower region of the climate cell. For example, the ventilation unit could be arranged on the roof, under the roof or otherwise on the roof of the climate cell. Preferably, however, it is provided that the ventilation unit is attached to a floor of the climate cell. For this purpose, the ventilation unit can be mounted or arranged on the floor respectively below the floor of the climate cell.

Preferably, the at least one air bag has openings at the height of the individual layers. For this purpose, the air bag can have a corresponding perforation, for example produced by means of a laser, or can be woven with different coarseness, and the air bag can also have an inhomogeneous woven fabric. The openings can be provided at the height of the individual layers in such a way that a predetermined amount of air respectively distribution is achieved at the height of the individual layers within the cultivation region. If this amount of air respectively distribution is to be changed or adapted, the air bag only has to be replaced by an air bag with different perforations. With rigidly installed systems, however, this would require a great deal of conversion work.

Furthermore, it is preferably provided that more openings and/or larger openings are arranged in a portion of the at least one air bag that is further away from the ventilation unit than in a portion arranged closer to the ventilation unit. If the ventilation unit is located in the lower region of the climate cell, fewer and/or smaller openings are thus preferably arranged in the lower portion than in the upper portion of the air bag. This achieves a particularly even distribution of the air at all levels respectively layers within the cultivation region of the climate cell.

The at least one air bag is preferably arranged in front of a first wall with a plurality of apertures in the direction of flow. For this purpose, the first wall can be formed, for example, as a mesh fabric strip or perforated sheet. The apertures are arranged at least in the regions of the individual layers, for example at the height of the plant cultivation containers and/or at the height of the lighting platforms. The apertures serve to distribute air in the cultivation region in a targeted and uniform manner. For this purpose, the apertures respectively through-openings are adapted to the corresponding flow requirements. The first wall with the plurality of apertures is preferably arranged in the direction of flow between the air bag and the individual layers.

It is also preferably provided that the at least one air bag is arranged between the first wall with the plurality of apertures and a closed wall. The first wall with the plurality of apertures is substantially parallel to the closed wall. Both walls thus form a kind of double wall respectively a space in which the at least one air bag is arranged respectively guided. Since the rear wall of this space is sealed off in a substantially airtight manner, the air released by the air bag can only be guided through the apertures in the first wall into the interior of the sealed climate cell respectively the cultivation region. The distance between the first wall with the plurality of apertures and the closed wall can be, for example, between 40 cm and 200 cm, particularly preferably between 50 cm and 150 cm, and very particularly preferably between 75 cm and 120 cm. The diameter of an air bag is preferably between 10 cm and 100 cm, particularly preferably between 20 cm and 80 cm, and very particularly preferably between 30 cm and 60 cm.

The first wall with the plurality of apertures is preferably arranged perpendicular to the layers and on an air supply side. A second wall with a plurality of apertures is arranged perpendicular to the layers on the air discharge side opposite the air supply side. In this case, the first and second walls are arranged in such a way that the individual layers extend completely between the two walls. Furthermore, the first wall and the second wall are preferably arranged parallel to each other. This achieves an air flow from the air supply side in a laminar manner and horizontally across the layers to the air discharge side. In the direction of flow, a closed wall is again arranged in parallel behind the second wall. This closed wall is arranged parallel to the second wall with the plurality of apertures and also, particularly preferably, parallel to the first wall with the plurality of apertures and the sealed wall arranged therebehind. As a result of the space between the second wall with the plurality of apertures and the closed wall arranged therebehind in the direction of flow, an air discharge portion extending vertically respectively in the height direction of the climate cell is formed.

There is preferably a negative pressure on the air discharge side, so that after the air has flowed in a laminar manner and horizontally over the layers, it is sucked in on the air discharge side by the negative pressure.

Preferably, a flow direction of the air through the climate cell respectively a cultivation region of the climate cell is oriented in a laminar manner, more specifically horizontally for climate cells with a rectangular base and radially for climate cells with a round base. From the ventilation unit, the air flows from the bottom to the top or from the top to the bottom on one side respectively on the air supply side of the layers, then through the openings of the air bag and through the apertures of the first wall over the plant cultivation containers and lighting platforms, and on the opposite side respectively the air discharge side again through the apertures of the second wall and then downwards or upwards back to the ventilation unit. The flow speed of the laminar air flow above the individual layers, in particular above the plant cultivation containers of a layer, is preferably between 0.1 m/s and 1.0 m/s. At these flow speeds directly above the individual plants, optimal growth can be ensured.

The at least one air bag is preferably configured such that a first volume flow of air above the plant cultivation containers of each layer is less than a second volume flow of air above the lighting platforms of each layer. Thus, less air volume per time unit is achieved directly above the plants and more air volume per time unit is achieved directly above the lighting platforms. In this way, an optimal and gentle air flow can be set for the plants and, at the same time, a correspondingly higher volume flow can be provided for better removal of the heat emitted by the lighting platforms in this region. Instead of the volume flow, the flow speed between the layers can also be different. Thus, two differently set volume flows and/or flow speeds are preferably provided per layer. The different volume flows at the height of the plant cultivation containers or the lighting platforms in each layer can be predetermined by a specific arrangement and/or size of the openings in the air bag at the corresponding points. The different flow rates at the height of the different layers can be predetermined by nozzles at the openings of the air bag or by a second air bag with different air pressure, whereby the first air bag and the second air bag preferably have openings on different layers and can thus flow alternately through the layers, for example by the first air bag having openings above the lighting platforms and the second air bag having openings directly above the plants.

On an air supply side, a plurality of air bags are preferably arranged next to each other, substantially along the entire depth of each layer. The air bags are arranged in the height direction within the climate cell respectively vertically and preferably substantially parallel to each other in the region between the first wall with the apertures and the closed wall arranged therebehind. The air bags can be arranged at a distance of between 10 cm and 100 cm, particularly preferably between 20 cm and 80 cm, and very particularly preferably between 30 cm and 70 cm from each other.

Furthermore, it is preferably provided that at least a second cultivation region is arranged behind the first cultivation region within the climate cell, and the climate and/or lighting in both cultivation regions can be controlled separately and independently of each other. Thus, a plurality of cultivation regions, particularly preferably three or more cultivation regions, can be arranged next to each other respectively one behind the other within the climate cell. The different cultivation regions within a climate cell take into account the different growth phases of the plants. In each cultivation region, for example, optimal lighting and an optimised climate can be created according to the particular growth phase. Particularly preferably, the cultivation regions arranged one behind the other are oriented according to the development of the plants respectively the order of the growth phases for the plants in question. The plant cultivation containers and/or lighting platforms can be moved from one cultivation region to the next cultivation region, as soon as the corresponding plants have reached a next growth phase. A separate climate system with a separate ventilation unit and separate air bags is provided for each cultivation region. The cultivation regions can be arranged one above the other and/or next to each other and/or behind each other.

Furthermore, the sealed climate cell has at least one automated transport system for displacing and/or inserting and/or removing the plant cultivation containers and the lighting platforms. Thus, the individual cultivation containers and lighting platforms can be inserted into the sealed climate cell by means of the automated transport system. For this purpose, an inlet opening can be opened briefly. Furthermore, the plant cultivation containers and/or lighting platforms can be removed from the climate cell by means of the automated transport system. The plant cultivation containers can, for example, be removed from one layer for relocation and then reinserted accordingly on another layer. When the plants are ready for harvesting, the plant cultivation containers are automatically removed from the climate cell by the transport system for further processing. Furthermore, the plant cultivation containers and/or the lighting platforms can be moved individually along a layer, for example from one cultivation region to the next, by means of the transport system depending on the particular requirements.

Particularly preferably, the sealed climate cell has two transport systems, which are arranged on opposite sides of the climate cell. Thus, one transport system can be used to insert the plant cultivation containers into the first cultivation region of the climate cell. The second transport system on the opposite side can remove the plant cultivation containers from the last cultivation region of the climate cell when the plants are ready for harvesting. Both the first and the second transport system can be used to displace the plant cultivation containers from one cultivation region to the next within the climate cell. In the case of a climate cell with a round cross-section, a transport system can be arranged in the centre for inserting the plant cultivation containers and/or lighting platforms. Alternatively or additionally, a transport system could be arranged in the outer region of the round climate cell for removing the plant cultivation containers and/or lighting platforms. A fully automatic transport system can, for example, also be used to automatically rotate respectively move the plant cultivation containers and/or the lighting platforms according to a set schedule. It is also possible to automatically position and/or displace the plant cultivation containers and/or lighting platforms depending on certain growth criteria of the plants or a predefined lighting plan for the lighting.

Since the sealed climate cell is preferably very compact inside and thus without aisles or paths, the automated transport system is also used to remove the lighting platforms for maintenance work respectively to replace individual lighting platforms according to the particular growth criteria. For this purpose, plant cultivation containers and lighting platforms must be easily and quickly exchangeable. This can be done fully automatically via a central control system using the transport system. Particularly preferably, the plant cultivation containers respectively the carrier platforms for a plurality of plant cultivation containers as well as the lighting platforms have substantially identical external dimensions so that both plant cultivation containers or carrier platforms for a plurality of plant cultivation containers as well as the lighting platforms can be transported respectively inserted, removed and/or moved by means of a transport system.

The plant cultivation containers and/or the lighting platforms are preferably provided with a machine-readable code, for example an RFID or barcode, so that they can be recognised and distinguished by the system in automated fashion. The code can also be used for traceability of the plant cultivation containers, for monitoring growth and for further processing.

The plant cultivation containers and the lighting platforms can be arranged on rollers respectively rails. Power rails and bus systems can be provided for the power supply and control of the lighting platforms.

Inside the sealed climate cell, there is preferably a supporting structure, against respectively on which the plant cultivation containers and the lighting platforms of the individual layers are displaceably mounted. For this purpose, the supporting structure has rails and/or rollers, against respectively on which the plant cultivation containers and the lighting platforms can be guided. This means that the rails or rollers do not have to be arranged on the walls of the climate cell. This considerably simplifies the mechanical construction of the climate cell itself. Particularly preferably, a single supporting structure is provided for each of the cultivation regions of a climate cell. This makes it possible to easily and flexibly displace the plant cultivation containers and the lighting platforms from one cultivation region to the next along one and the same supporting structure. The transport systems for loading and unloading the plant cultivation containers and the lighting platforms can be arranged on two opposite sides of the supporting structure. Furthermore, the supporting structure is preferably arranged entirely between the first wall with the plurality of apertures and the second wall with the plurality of apertures.

According to the invention, a plant cultivation system with a plurality of sealed climate cells as described above is also provided. For this purpose, the plurality of sealed climate cells within the plant cultivation system are arranged parallel to each other. This means that the sealed climate cells are arranged parallel respectively next to each other in such a way that parallel respectively simultaneous cultivation of plants is possible. Each climate cell is climatically sealed within itself. Furthermore, each climate cell can have a plurality of cultivation regions. All climate cells of the plant cultivation system are arranged within a closed system with six common outer sides respectively outer walls. The closed walls between the individual climate cells for separating them can, particularly preferably, be thinner than the common outer walls. The sealed climate cells can be arranged one above the other and/or next to each other and/or behind each other, and the plant cultivation system is preferably longer than 100 m, wider than 20 m and higher than 30 m.

### BRIEF DESCRIPTION OF THE DRAWINGS

The invention is explained below by way of example using preferred embodiments.

The figures show schematically:

FIG. 1: a climatically sealed climate cell with a plurality of layers arranged one above the other,

FIG. 2: a plant cultivation system with a plurality of sealed climate cells arranged parallel to each other, with each climate cell having a plurality of cultivation regions,

FIG. 3a: a cross-section through a cultivation region of a sealed climate cell,

FIGS. 3b, c: two perspective views of a cultivation region of a sealed climate cell and

FIG. 4: a supporting structure of a sealed climate cell.

### PREFERRED EMBODIMENTS OF THE INVENTION

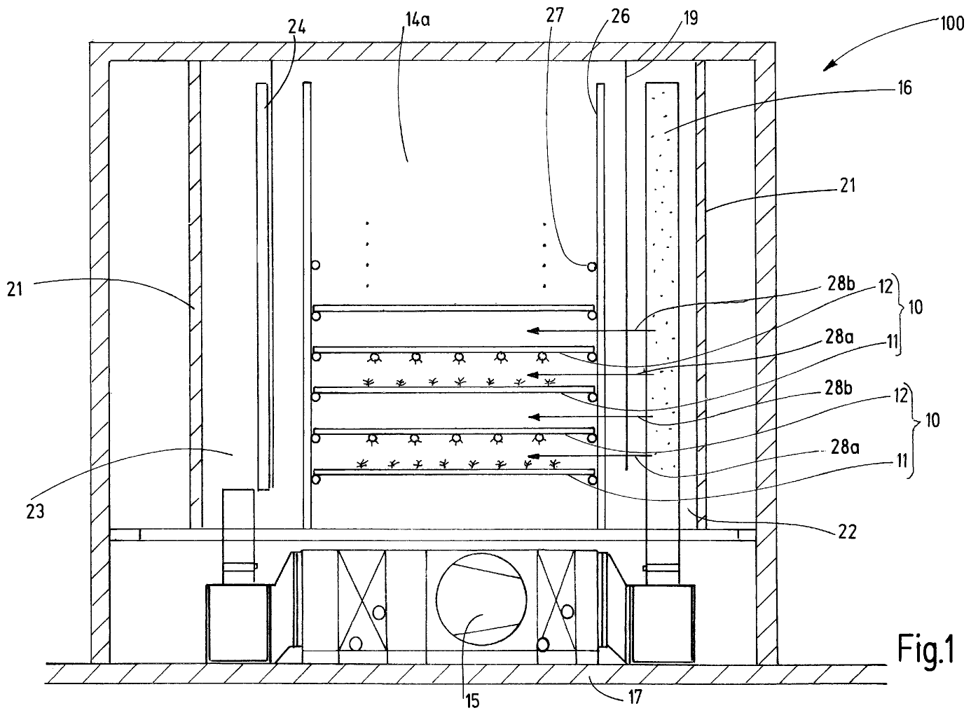

FIG. 1 shows a climatically sealed climate cell 100 for cultivating plants indoors. Within the climatically sealed climate cell 100, a plurality of layers 10 are arranged one above the other. Each layer 10 in turn has a plant cultivation container 11 and a lighting platform 12 arranged thereabove.

A ventilation unit 15 of a first climate system 13a is arranged on the floor 17 of the climate cell 100. The air supply side 22 runs in the height direction respectively vertically within the climate cell 100 between a closed outer wall 21 and a first wall 19 with apertures 20. Between the closed wall 21 and the first wall 19 with the apertures 20, air bags 16 that are perforated respectively provided with holes also run in the height direction.

There is a negative pressure on the air discharge side 23 opposite the air supply side 22. The air thus flows from the ventilation unit 15 up through the air bag 16 and out of the openings respectively perforation of the air bag 16 at the level of each individual layer 10 in a laminar manner respectively horizontally over the plant cultivation containers 11 and the lighting platforms 12 to the air discharge side 23. On the air discharge side 23, the air flows through the apertures 20 of the second wall 24 and from there down and back to the ventilation unit 15.

The perforation in the air bags 16 is designed in such a way that a targeted and predetermined flow speed can be achieved at the height of the individual layers 10. For each layer 10, there are two air flows: a first air flow 28a with a lower flow speed directly above the plants respectively the plant cultivation containers 11, and a second air flow 28b with a higher flow speed directly above the lighting platforms 12 for removing the heat emitted by the lighting platforms 12. Furthermore, the perforation of the air bags 16 is designed in such a way that uniform air flows 28 respectively flow speeds are achieved for each layer 10. For this purpose, the air bags 16 have fewer respectively smaller openings in the lower region than in the upper portion of the air bags 16.

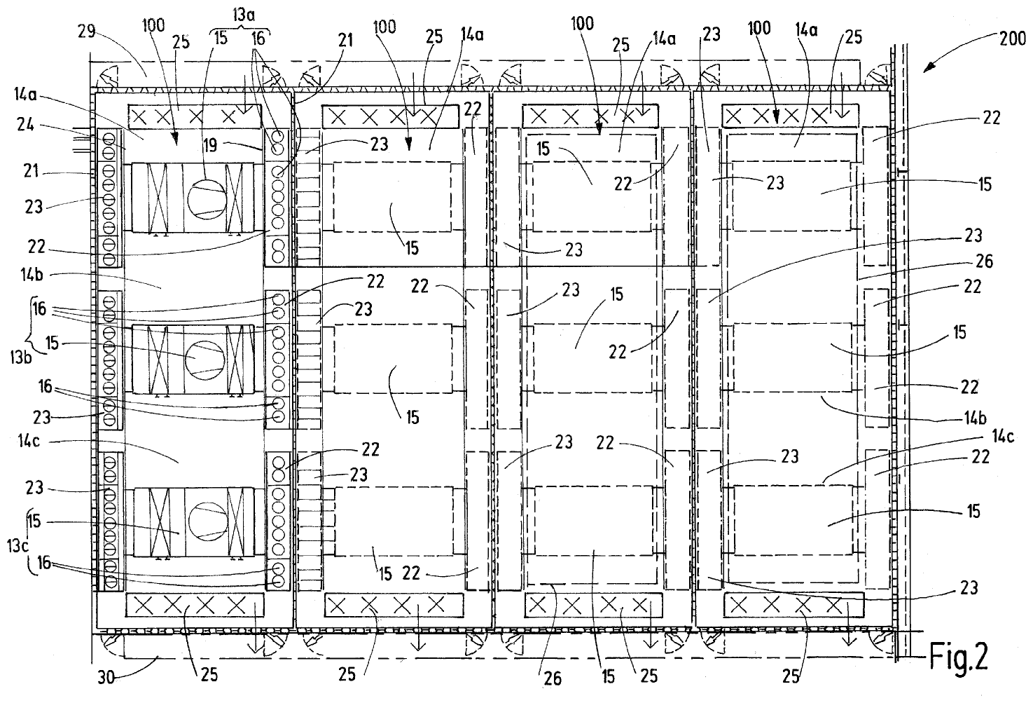

FIG. 2 shows a plant cultivation system 200 with three sealed climate cells 100 arranged next to respectively parallel to each other. Each of the individual climate cells 100 has four cultivation regions 14a, 14b, 14c arranged one behind the other.

A separate climate system 13a, 13b, 13c is provided for each cultivation region 14a, 14b, 14c. Each of the climate systems 13a, 13b, 13c has a separate ventilation unit 15 and separate air bags 16.

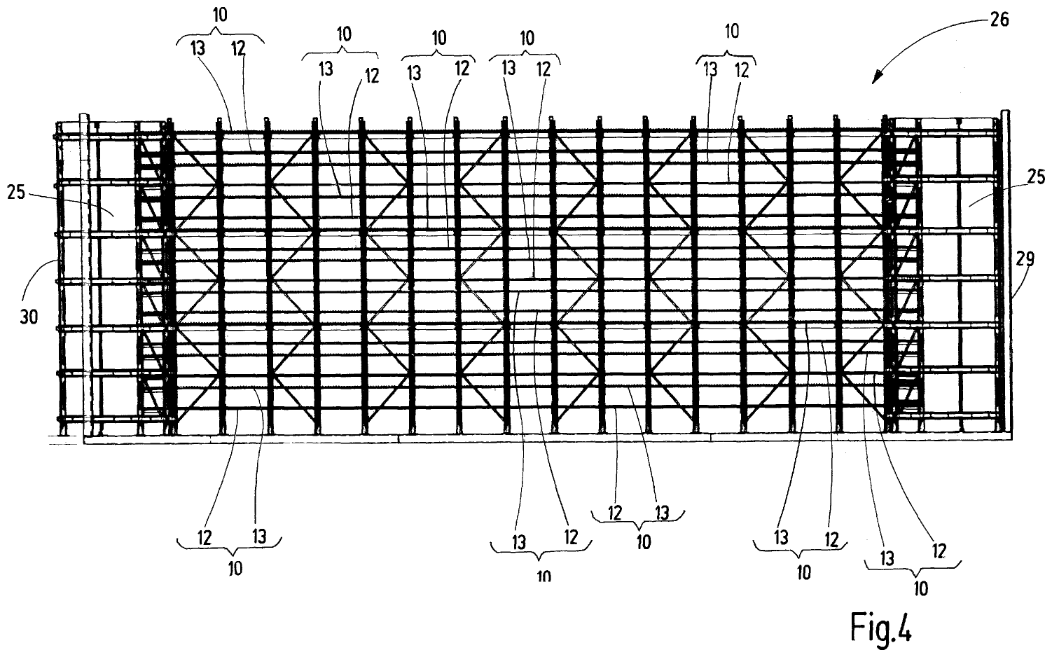

In this way, different growth phases of the plants can be taken into account in each climate cell 100. Within each climate cell, a supporting structure 26 is arranged, which extends from the inlet opening 29 to the outlet opening 30 of the particular climate cell 100 and thus over all three cultivation regions 14a, 14b, 14c. The supporting structure 26 is also shown in FIG. 4. The supporting structure 26 is used to place respectively hold the plant cultivation containers 11 and lighting platforms 12 on the individual layers 10. For this purpose, the supporting structure 26 has rails 27 or rollers at the height of the individual layers 10, along which the plant cultivation containers 11 and the lighting platforms 12 can be moved. Since a single supporting structure 26 extends over all the cultivation regions 14a, 14b, 14c, the plant cultivation containers 11 and also the lighting platforms 12 can be moved in a simple manner by means of the transport systems 25 along a layer 10 from the first cultivation region 14a to the second cultivation region 14b and further to the third cultivation region 14c.

A supporting structure 26 is thus arranged above all the cultivation regions 14a, 14b, 14c in each climate cell 100. Furthermore, two transport systems 25 are provided for each climate cell 100, with one transport system 25 being arranged in the region of the inlet opening 29 and the other transport system 25 being arranged in the region of the outlet opening 30 of the particular climate cell 100. The transport systems 25 are thus used for inserting, removing and moving respectively displacing the plant cultivation containers 11 and the lighting platforms 12. As shown in FIG. 2, separate transport systems 25 are provided for the individual climate cells 100 of the plant cultivation system 200. Alternatively, common transport systems 25 could also be provided for the individual climate cells 100 of the plant cultivation system 200 in the region of the inlet openings 29 and in the region of the outlet openings 30. In this case, the transport systems 25 would move respectively transport plant cultivation containers 11 and lighting platforms 12 not only in the vertical direction, but also in the horizontal direction.

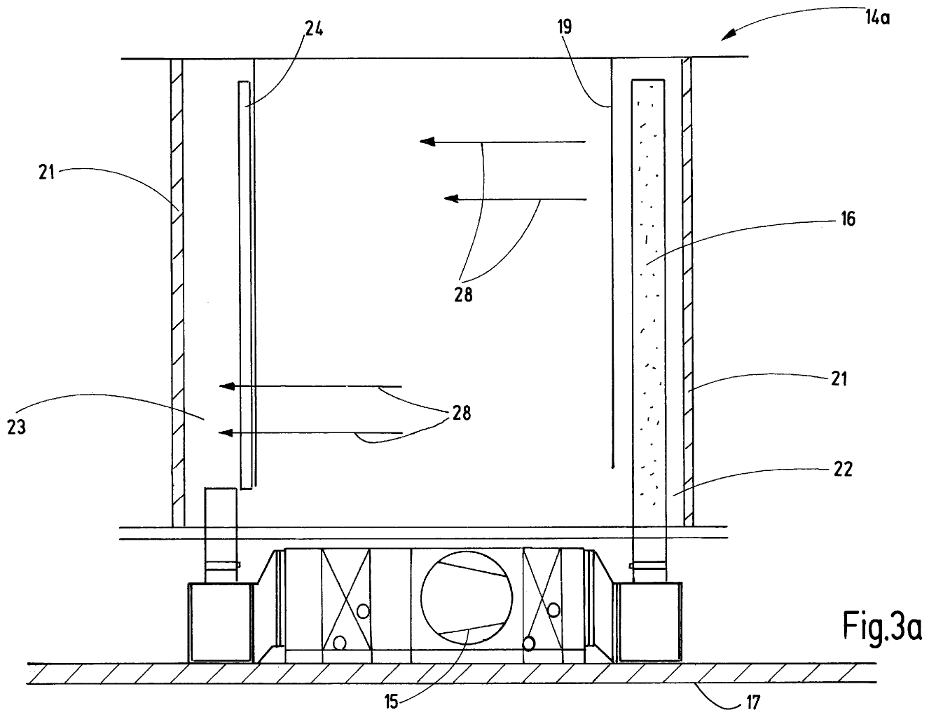

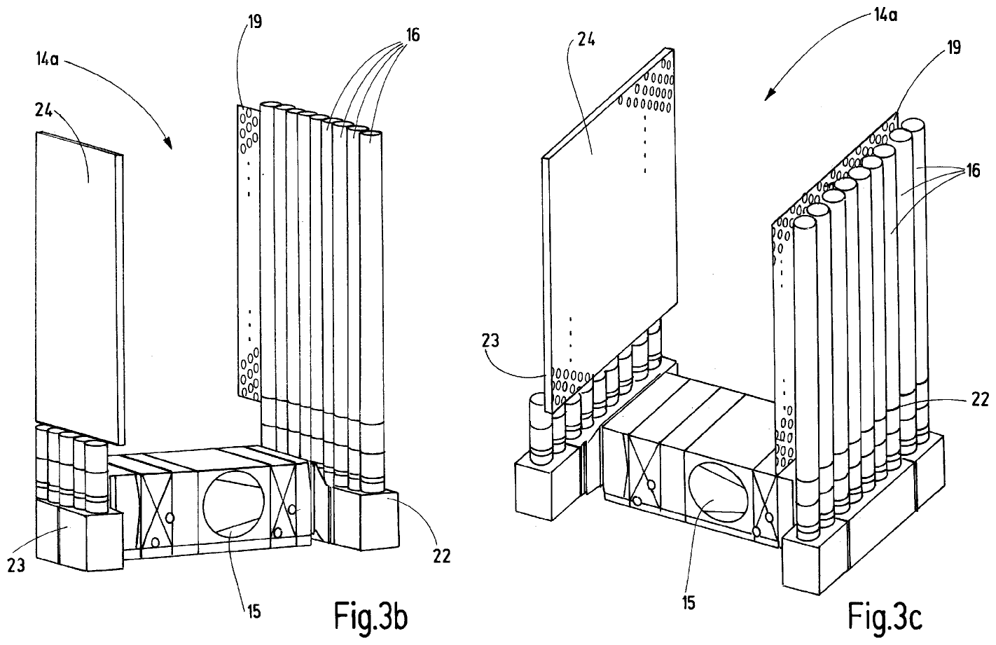

FIGS. 3a to 3c show a cultivation region 14a, 14b, 14c of a climate cell 100 from FIGS. 1 and 2. Here, a cross-section through a first cultivation region 14a is shown in FIG. 3a. FIGS. 3b and c each show a perspective view of the first cultivation region 14a.

From the various views of the first cultivation region 14a, the arrangement of the individual elements of the first climate system 13a is once again clearly evident. The first climate system 13a has a ventilation unit 15 arranged on the floor 17 of the climate cell 100. Along the air supply side 22, a plurality of perforated air bags 16 are arranged parallel to and spaced apart from each other from bottom to top. The air supply side 22 is formed here by the space between a closed wall 21 and a first wall 19 with a plurality of apertures 20. On the opposite air discharge side 23, a closed wall 21 is also provided on the outside, and a second wall 24 with a plurality of apertures 20 is provided towards the inside, through which the air flow 28 is drawn in and transported downwards to the ventilation unit 15.

FIG. 4 shows a supporting structure 26, as is inserted into the individual climate cells 100 of the plant cultivation system 200 shown in FIG. 2. The two outer side regions of the supporting structure 26 form the inlet opening 29 and outlet opening 30 of the climate cell 100. Furthermore, a transport system 25 is arranged in each of these regions for inserting the plant cultivation containers 21 and the lighting platforms 12 and for removing the plant cultivation containers 11 and the lighting platforms 12.

The supporting structure 26 has rails 27 spaced apart from one another in the height direction for supporting respectively receiving the plant cultivation containers 11 and the lighting platforms 12. The supporting structure 26 shown by way of example in FIG. 4 has nine layers 10 arranged one above the other. On each layer 10, a plurality of plant cultivation containers 11 and lighting platforms 12 are arranged one above the other.

### LIST OF REFERENCE SIGNS

100 Sealed climate cell
200 Plant cultivation system
10 Layer
11 Plant cultivation container
12 Lighting platform
13a First climate system
13b, 13c Further climate systems
14a First cultivation region
14b Second cultivation region
14c Third cultivation region
15 Ventilation unit
16 Air bag
17 Climate cell floor
18 Flow direction
19 First wall
20 Apertures
21 Closed wall
22 Air supply side
23 Air discharge side
24 Second wall
25 Transport system
26 Supporting structure
27 Rail
28 Air flow
28a First air flow
28b Second air flow
29 Inlet opening
30 Outlet opening

1. A sealed climate cell for plant cultivation in a plurality of layers which are arranged one above the other, each layer having at least one plant cultivation container and a lighting platform arranged thereabove, a climate in a first cultivation region within the climate cell being controlled by means of a ventilation unit of a first climate system, wherein
the first climate system has at least one air bag which runs in the height direction, is arranged within the climate cell, and is designed to supply air to the individual layers in the first cultivation region.

2. The sealed climate cell according to claim 1, wherein
the ventilation unit is attached to a floor of the climate cell.

3. The sealed climate cell according to claim 1, wherein
the at least one air bag is provided with openings.

4. The sealed climate cell according to claim 3, wherein
more openings and/or larger openings are arranged in a portion of the at least one air bag that is further away from the ventilation unit than in a portion arranged closer to the ventilation unit.

5. The sealed climate cell according to claim 1, wherein
the at least one air bag is arranged in front of a first wall with a plurality of apertures in the direction of flow.

6. The sealed climate cell according to claim 5, wherein
the at least one air bag is arranged between the first wall with the plurality of apertures and a closed wall.

7. The sealed climate cell according to claim 5, wherein
the first wall is arranged perpendicular to the layers and on an air supply side, a second wall with a plurality of apertures being arranged perpendicular to the layers on an air discharge side opposite the air supply side, in such a way that the individual layers extend completely between the first wall and the second wall.

8. The sealed climate cell according to claim 1, wherein
a flow direction of the air through the climate cell is oriented in a laminar manner, specifically horizontally for climate cells with a rectangular base and radially for climate cells with a round base.

9. The sealed climate cell according to claim 7, wherein
there is a negative pressure on the air discharge side.

10. The sealed climate cell according to claim 1, wherein
the at least one air bag is formed such that a first volume flow of air above the plant cultivation container of each layer is less than a second volume flow of air above the illumination platform of each layer.

11. The sealed climate cell according to claim 1, wherein
on an air supply side a plurality of air bags are arranged side by side substantially along an entire depth of each layer.

12. The sealed climate cell according to claim 1, wherein
at least one second cultivation region is arranged within the climate cell behind and/or above the first cultivation region, the climate and/or lighting in both cultivation regions being controllable separately from one another.

13. The sealed climate cell according to claim 1, wherein
the climate cell has an automated transport system for displacing and/or inserting and/or removing the plant cultivation containers and the lighting platforms.

14. The sealed climate cell according to claim 1, wherein
the plant cultivation containers and/or the lighting platforms are provided with a machine-readable code.

15. The sealed climate cell according to claim 1, wherein
a supporting structure is arranged in the interior of the sealed climate cell, on which the plant cultivation containers and the lighting platforms of the individual layers are displaceably arranged.

16. A plant cultivation system comprising a plurality of sealed climate cells according to claim 1, wherein
the sealed climate cells are arranged parallel to each other.
